(19) United States
(12) Patent Application Publication
(10) Pub. No.: US 2012/0165966 A1
(43) Pub. Date: Jun. 28, 2012

(54) METHOD AND APPARATUS FOR OUTPUTTING AUDIO DATA

(75) Inventor: Hak-Sung LYOU, Gyeongsangbuk-do (KR)

(73) Assignee: SAMSUNG ELECTRONICS CO., LTD., Gyeonggi-Do (KR)

(21) Appl. No.: 13/337,408

(22) Filed: Dec. 27, 2011

(30) Foreign Application Priority Data
Dec. 27, 2010 (KR) 10-2010-0136010

(51) Int. Cl. G06F 17/00

(52) U.S. Cl. 700/94

(57) ABSTRACT

The present disclosure relates to a method and an apparatus for outputting audio data, wherein audio data having uncompressed audio data and compressed data to be output in response to a predetermined generated event is identified, and the uncompressed audio data is played back after determining that the identified audio data includes the uncompressed audio data and the compressed audio data in the identified audio data is played subsequently after the completion of the uncompressed audio data playback.

### CLAIM OF PRIORITY

This application claims priority under 35 U.S.C. §119(a) to a Korean Patent

Application entitled “Method and Apparatus for Outputting Audio Data” filed in the Korean Intellectual Property Office on Dec. 27, 2010 and assigned Serial No. 10-2010-0136010, the contents of which are incorporated herein by reference.

### BACKGROUND OF THE INVENTION

1. Field of the Invention

The present invention relates to the output of audio data, and more particularly to a method and an apparatus for outputting audio data while reducing the time required for starting the output of the audio data.

2. Description of the Related Art

Usually, the term “portable terminal” refers to an electronic device providing a function in which a user talks on the phone and/or exchanges data with another user while roaming. With the diversification and development of an environment for mobile communication, the application of a portable terminal, which has only previously been used for voice telephony, is becoming increasingly diversified.

Meanwhile, a portable terminal provides a function in which a user can easily identify a use state of the portable terminal by providing a feeding back in form of mechanic and/or audio alert. For example, when an event (e.g. key input from the user) is generated, a vibration feedback responsive to and/or an audio output feedback for notifying the generated event can occur.

Particularly, the audio feedback function is provided to the user as a useful feedback function by outputting audio data corresponding to a pressed key when the key is pressed. However, it is necessary to decode the audio data corresponding to the generated event and then output the decoded audio data. To this end, a predetermined calculation time is required to decode the audio data.

Namely, when an event (e.g. the key input from the user) is generated, the conventional audio feedback function outputs audio data corresponding to the generated event after decoding the audio data, so that it cannot output the audio data immediately when the event is generated.

According to this conventional audio feedback function, although the event corresponding to the output of the audio data is eventually generated, the audio data corresponding to the generated event is output with a delay of some time period (e.g. the amount of time for decoding), and thus the delayed output of the audio data implies that an immediate feedback function cannot be provided to the user without the time delay.

Particularly, when a user continuously and quickly presses keys, the conventional audio feedback function requires a longer time period to decode audio data corresponding to each input key and then output the decoded audio data. As a result, a problem arises in that the user cannot immediately identify the feedback on each input key.

### SUMMARY OF THE INVENTION

Accordingly, the present invention has been made to solve the above-mentioned problems occurring in the prior art, and the present invention proposes a method and an apparatus, by which the time required until the start of the playback of audio data can be minimized so that the audio data corresponding to a generated event can be quickly played back without a delay while maintaining the size of the audio data small.

In accordance with an aspect of the present invention, a method for outputting audio data includes: identifying audio data to be output in response to a predetermined generated event; playing back uncompressed audio data after determining whether the identified audio data includes the uncompressed audio data; and playing back compressed audio data in the identified audio data when the playback of the uncompressed audio data is completed.

In accordance with another aspect of the present invention, an apparatus for outputting audio data includes: a memory for storing at least one audio data to be output in response to each generated event; and a controller for identifying audio data to be output in response to a predetermined generated event, playing back uncompressed audio data after determining whether the identified audio data includes the uncompressed audio data, and playing back compressed audio data in the identified audio data when the playback of the uncompressed audio data is completed. In accordance with an aspect of the present invention, a method for outputting audio data includes: identifying audio data comprised of uncompressed audio data and compressed audio data to be output in response to a predetermined generated event; playing back the uncompressed audio data and simultaneously decoding the compressed audio data and playing back the compressed audio data when the playback of the uncompressed audio data is completed.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is a block diagram illustrating the configuration of a portable terminal according to an exemplary embodiment of the present invention;

FIG. 2 is a flowchart showing a process for outputting audio data according to an exemplary embodiment of the present invention; and

FIG. 3 is an illustrative view showing audio data according to an exemplary embodiment of the present invention.

### DETAILED DESCRIPTION OF THE EXEMPLARY EMBODIMENTS

Hereinafter, exemplary embodiments of the present invention will be described in detail with reference to the accompanying drawings.

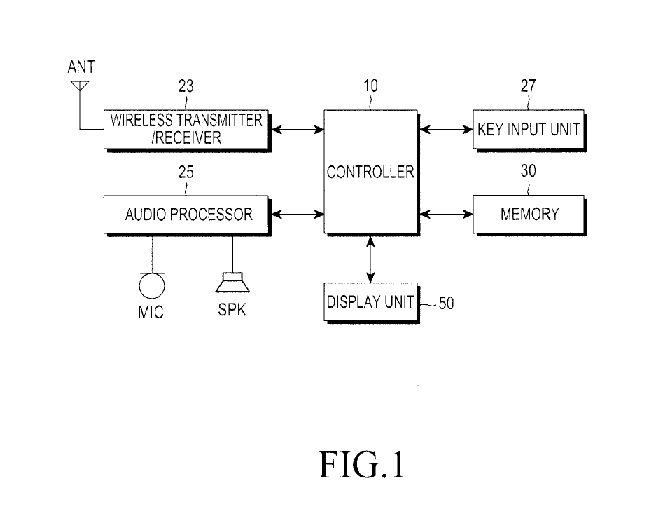

FIG. 1 is a block diagram illustrating the configuration of a portable terminal according to an exemplary embodiment of the present invention.

Although the present invention related to reducing the amount of time necessary prior to the output of audio corresponding to a generated event may be applied to all electronic devices capable of outputting audio data, it is assumed that the present invention is practiced through an electronic device (e.g. a portable terminal) which has high portability and has a lower calculation processing speed for processing audio data than a desktop computer having a high-performance.

The portable terminal according to an exemplary embodiment of the present invention, which is a mobile electronic device having high portability, may be either a videophone, a typical mobile phone (e.g. a feature phone), a smart phone, an IMT-2000 (International Mobile Telecommunication 2000) terminal, a WCDMA (Wideband Code Division Multiple Access) terminal, a UMTS (Universal Mobile Telecommunication Service) terminal, a PDA (Personal Digital Assistant), a PMP (Portable Multimedia Player), a DMB (Digital Multimedia Broadcasting) device, or a laptop computer, and it will be apparent to those skilled in the art that the portable terminal is not limited to any of these devices.

Although devices, including a GPS (Global Positioning System) module, a camera module, a Bluetooth module, an acceleration sensor, a proximity sensor, a Geo-magnetic sensor, a DMB (Digital Multimedia Broadcasting) receiver, etc., which may be included in a portable terminal, are not shown in FIG. 1, it will be apparent to those skilled in the art that these devices, which are not shown in FIG. 1, may be included in a portable terminal according to an exemplary embodiment of the present invention in order to provide the relevant functions of these devices.

For example, the acceleration sensor may measure dynamic forces including acceleration, vibration, impact, etc. and then sense a motion state of the portable terminal. Then, it may sense a display direction of a display unit of the portable terminal by using the sensed motion state.

Also, the proximity sensor may sense the proximity of a part of a user's body to the portable terminal, and thus may be used to prevent the malfunction of the portable terminal providing a touchscreen function.

Also, a gyroscope may be used to sense rotary motions of 6 axes (i.e. up and down, left and right, the front and the rear, x-axis, y-axis, and z-axis) of a rotating portable terminal in connection with the acceleration sensor in observing a dynamic motion of the rotating portable terminal.

Hereinafter, the portable terminal according to an exemplary embodiment of the present invention will be described below in consideration of the above description and with reference to FIG. 1.

As shown in FIG. 1, a wireless transmitter/receiver 23 includes an RF (Radio Frequency) unit and a modem (modulator/demodulator). The RF unit includes an RF transmitter for upconverting the frequency of a signal to be transmitted and then amplifying the frequency-upconverted signal, an RF receiver for low-noise amplifying a received signal and then downconverting the frequency of the low-noise amplified signal, etc. The modem includes a transmitter for encoding and modulating a signal to be transmitted, a receiver for demodulating and decoding a signal received by the RF unit, etc.

The wireless transmitter/receiver 23 according to an exemplary embodiment of the present invention may receive audio data provided in response to the generated event. For example, when a predetermined audio data pack has been received by the wireless transmitter/receiver 23 and is applied to the portable terminal, a user can receive different audio data according to generated events through audio data included in the received audio data pack.

An audio processor 25 may include a codec (coder/decoder), and the codec may include a data codec and an audio codec. The data codec processes packet data, etc., and the audio codec processes audio signals including voice, a multimedia file, etc. Since the audio processor 25 may be included in a controller 10, functions provided by the audio processor 25 may be equally provided by the controller 10. The audio processor 25 converts a digital audio signal, which has been received by the modern, to an analog signal through the audio codec, and then reproduces the analog signal. Also, the audio processor 25 converts an analog audio signal, which is generated from a microphone, to a digital audio signal through the audio codec, and then transmits the digital audio signal to the modem. The codec may be separately provided, or may be included in a controller 10 of the portable terminal.

The audio processor 25 according to an exemplary embodiment of the present invention decodes and then plays back uncompressed audio data encoded by an decompression codec (i.e. a lossless codec), such as either RIFF (Resource Interchange File Format), IFF (Interchange File Format), AIFF (Audio Interchange File Format), PCM Wave (Purse Code Modulation Wave) or the like.

Also, when audio data has been compressed (i.e. compressed/encoded) by a predetermined compression codec (i.e. a lossy codec), such as either MP3 (MPEG-1 Audio Layer 3), AAC (Advanced Audio Coding), Ogg Vorbis, RA (Real Audio), WMA (Windows Media Audio), ATRAC (Adaptive Transform Acoustic Coding) or the like, the audio processor 25 according to an exemplary embodiment of the present invention decodes the compressed audio data through a corresponding codec, and then plays back (or outputs) the decoded audio data.

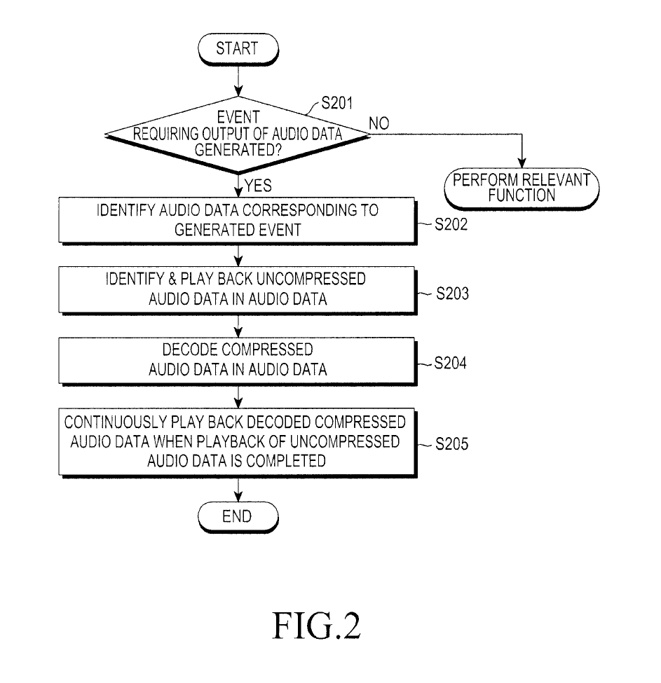

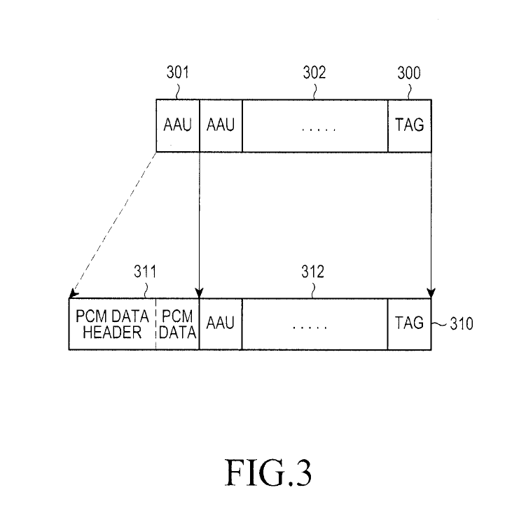

Meanwhile, the audio processor 25 according to an exemplary embodiment of the present invention plays back audio data 310 shown in FIG. 3 according to an exemplary embodiment of the present invention under the control of the controller 10. A detailed operation of the audio processor 25 for performing the above playback will be described later with reference to a flowchart shown in FIG. 2.

A key input unit 27 may include keys for inputting numbers and text information and function keys for setting various functions, and may be in the form of either a touchpad or the like. When a display unit 50 employs a touchscreen, the key input unit 27 according to an exemplary embodiment of the present invention may be excluded from the configuration of the portable terminal, or may include only a preset minimum number of keys. Therefore, the display unit 50 may replace some of key input functions of the key input unit 27 by the functions of itself.

A memory 30 may include a program memory and a data memory. The program memory stores programs for controlling a general operation of the portable terminal. The memory 30 may include external memories, including a CF (Compact Flash) memory card, an SD (Secure Digital) memory card, a Micro-SD (Micro Secure Digital) memory card, a Mini-SD (Mini Secure Digital) memory card, an XD (Extreme Digital) memory card, a memory stick, etc., or may include storage devices, including an HDD (Hard Disk Drive), an SSD (Solid State Drive), etc.

The memory 30 according to an exemplary embodiment of the present invention stores at least one audio data to be output in response to the generation of an event (e.g. key input or the execution/completion of an application) in the portable terminal. In an exemplary embodiment of the present invention, the audio data 310 stored in the memory 30 includes uncompressed audio data 311 and compressed audio data 312. The audio data 310 according to an exemplary embodiment of the present invention will be described below with reference to FIG. 3.

First, conventional audio data will be described below. In order to save storage space, conventional audio data 300 shown in FIG. 3 includes only the compressed audio data, which is to be stored, encoded in a compressed format such as MP3 or WMV (Windows Media Video).

FIG. 3 illustrates an example where the conventional audio data 300 includes compressed audio data in the MP3 format among many compressed formats. The MP3 format includes multiple AAUs (Audio Access Units) and a single audio TAG, and a single AAU again includes a Header, CRC (Cyclic Redundancy Checking), Sideinfo, and sound data (actual data related to the playback of audio). It is assumed that an AAU 301 in the audio data 300 is an AAU corresponding to a playback interval from a first playback interval of the audio data 300.

When the audio data includes only compressed audio data as described above, it possible to save storage space, but there is a disadvantage in that a predetermined amount of time period is required to decode the audio data. Therefore, when audio data corresponding to the generation of an event in the portable terminal is played back and an audio feedback function is then provided to a user, the playback of the conventional audio data 300 causes a problem such that a sound (i.e. audio data) corresponding to the generation of an event cannot be immediately played back due to the time required to decode the compressed audio data.

Meanwhile, when audio data includes only uncompressed audio, it possible to reduce the amount of time required to decode the audio data and immediately play back a sound (i.e. audio data) corresponding to the generation of an event without delay. However, uncompressed audio data requires a larger amount of storage space than compressed audio data. Therefore, when the number of audio data corresponding to the various generated events becomes large, there is a disadvantage in that the amount of storage space required to store audio data, which includes only uncompressed audio data, becomes large.

Accordingly, in an exemplary embodiment of the present invention, the audio data 310 includes uncompressed audio data until an interval within a predetermined amount of time period from a playback start interval and includes compressed audio data after the end of the playback interval of the uncompressed audio data during the entire playback interval of the audio data. Thus, the audio data 310 according to an exemplary embodiment of the present invention can minimize an increase in the size of audio data to be output in response to the generation of an event while causing a sound corresponding to the generation of an event to be quickly output without delay.

More specifically, the audio data 310 shown in FIG. 3 includes uncompressed audio data 311 and compressed audio data 312. Herein, the uncompressed audio data 311, which represents audio data corresponding to a playback interval from the start playback interval, is audio data which is first played back when the audio data 310 is played back. For example, it can be understood that the playback interval of the uncompressed audio data 311 corresponds to a playback interval of the compressed audio data AAU 301. Also, the uncompressed audio data 311 is audio data in an uncompressed format such as PCM Wave, and thus is audio data which can be played back without a complex calculation process as compared with the compressed audio data 301.

The compressed audio data 312 is audio data corresponding to a playback interval after the uncompressed audio data 311 in the entire playback interval of the audio data 310. While the uncompressed audio data 311 is played back, the compressed audio data 312 is decoded by the audio processor 25 or the controller 10, then the decoded audio data 312 is continuously played back after the completion of the play back of the uncompressed audio data 311.

The display unit 50 may be implemented by an LCD (Liquid Crystal Display), and/or an OLED (Organic Light-Emitting Diode, such as either a PMOLED (Passive Matrix Organic LED) or an AMOLED (Active Matrix Organic LED)), and outputs various pieces of display information provided by the portable terminal. The display unit 50 according to an exemplary embodiment of the present invention may include a touchscreen, and then serve as an input unit for controlling the portable terminal, together with the key input unit 27.

The controller 10 may control an overall operation of the portable terminal according to an exemplary embodiment of the present invention, and may change and control the operation of the portable terminal by a user's input provided by either the key input unit 27, the display unit 50, or the like. When determining that an event, which requires the output of audio data, has been generated, the controller 10 according to an exemplary embodiment of the present invention identifies audio data to be output in response to the generated event, and while first playing back uncompressed audio data in the identified audio data, decodes compressed audio data. Then, when the playback of the uncompressed audio data is completed, the controller 10 continuously plays back the decoded compressed audio data.

FIG. 2 is a flowchart showing a process for outputting audio data according to an exemplary embodiment of the present invention. A method for reducing the time required to output audio data according to an exemplary embodiment of the present invention will be described below with reference to FIGS. 1 to 3.

In steps S201 and S202, the controller 10 determines whether an event, which requires the output of audio data, has been generated in the portable terminal, and then identifies audio data corresponding to the generated event.

A user may use (i.e. operate) the portable terminal to generate an event, such as key input or the like, while using the portable terminal. The controller 10 identifies audio data to be output in response to the generated event from the memory 30.

In steps S203 and S204, the controller 10 identifies and then plays back uncompressed audio data in the identified audio data, and simultaneously, identifies and then decodes compressed audio data.

When identifying the audio data, which has been output in response to the generated event, in the above steps, the controller 10 determines whether the identified audio data includes uncompressed audio data. Next, the controller 10 plays back the uncompressed audio data, and then provides an audio feedback function to the user.

At this time, the controller 10 according to an exemplary embodiment of the present invention plays back the uncompressed audio data, and simultaneously (or in a predetermined amount of time after the playback), identifies compressed audio data included in the identified audio data and then decodes the identified compressed audio data. Namely, the controller 10 according to an exemplary embodiment of the present invention decodes the compressed audio data, which is to be continuously played back after the completion of the playback of the uncompressed audio data, while playing back the uncompressed audio data.

In step S205, when the playback of the uncompressed audio data is completed, the controller 10 continuously plays back the decoded compressed audio data after the playback of the uncompressed audio data.

The controller 10 plays back the compressed audio data, which has been decoded while having played back the uncompressed audio data when the playback of the uncompressed audio data is completed. It is desirable that the controller 10 plays back the compressed audio data, which has previously been decoded, continuously after the playback of the uncompressed audio data. Thereafter, the controller 10 decodes and plays back the uncompressed audio data until the playback interval is completed.

Referring to FIG. 3, when audio data, which is to be played back in response to the generated event, is identified as the audio data 310, the controller 10 decodes the compressed audio data 312 while first playing back the uncompressed audio data 311. Next, when completing the playback of the uncompressed audio data 311, the controller 10 continuously plays back the decoded compressed audio data 312.

Meanwhile, although the compressed audio data has been described as having the MP3 format and the uncompressed audio data has been described as having the PCM Wave format with reference to FIG. 3, the present invention is not limited to this configuration, and thus it will be apparent to those skilled in the art that the compressed audio data may be replaced by compressed audio data in the compressed format, such as either AAC, Ogg Vorbis, RA, WMA, ATRAC or the like, and the uncompressed audio data may be replaced by uncompressed audio data in the uncompressed format, such as either RIFF, IFF, AIFF or the like.

According to the present invention, while audio data corresponding to the generated event is quickly played back without delay, the size of audio data to be output in response to the generated event can be kept small.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM. ROM, Flash, etc. that may store or receive software or computer code that when accessed and executed by the computer, processor or hardware implement the processing methods described herein.

Hitherto, it has been described in an exemplary embodiment of the present invention that when audio data corresponding to the generation of an event is output and then an audio feedback function is provided to a user, it is possible to minimize the time required until the start of the playback of the audio data while the size of the audio data is kept small. However, it will be apparent that the above-described exemplary embodiment is only for an illustrative purpose and is not meant to be a limitation of the present invention.

Therefore, changes in the elements, such that an element may be equally replaced by another element in an embodiment of the present invention without departing from the technical idea or field of the present invention provided by the appended claims, will fall within the scope of the present invention. Hence, the spirit and scope of the present invention must be defined not by the described embodiments thereof but by the appended claims and equivalents of the appended claims.

What is claimed is:

1. A method for outputting audio data, the method comprising:
identifying audio data to be output in response to a predetermined generated event;
playing back uncompressed audio data when it is determined that the identified audio data comprises the uncompressed audio data; and
playing back compressed audio data in the identified audio data when the playback of the uncompressed audio data is completed.

2. The method as claimed in claim 1, further comprising decoding the compressed audio data in the identified audio data during the play back of the uncompressed audio data.

3. The method as claimed in claim 1, wherein the decoded compressed audio data is continuously played after the completion of the playback of the uncompressed audio data.

4. The method as claimed in claim 1, wherein the compressed audio data corresponds to compressed data in a Moving Picture Experts Group-1 Audio Layer 3 (MP3) format, and the uncompressed audio data corresponds to uncompressed data in a Purse Code Modulation Wave (PCM Wave) format.

5. The method as claimed in claim 1, wherein the audio data comprises the uncompressed audio data prior to a playback start interval and comprises the compressed audio data after an end of the playback interval of the uncompressed audio data.

6. An apparatus for outputting audio data, comprising:
a memory for storing at least one audio data having an uncompressed audio data and compressed audio data; and
a controller for identifying the audio data to be output in response to a predetermined generated event, playing back the uncompressed audio data after determining the identified audio data comprises the uncompressed audio data, and playing back the compressed audio data in the identified audio data after the playback of the uncompressed audio data is completed.

7. The apparatus as claimed in claim 6, wherein the controller decodes the compressed audio data in the identified audio data while playing back the identified uncompressed audio data.

8. The apparatus as claimed in claim 6, wherein the compressed audio data corresponds to compressed audio data in a Moving Picture Experts Group-1 Audio Layer 3 (MP3) format, and the uncompressed audio data corresponds to uncompressed audio data in a Purse Code Modulation Wave (PCM Wave) format.

9. The apparatus as claimed in claim 6, wherein the audio data comprises the uncompressed audio data prior to a playback start interval and comprises the compressed audio data after an end of the playback interval of the uncompressed audio data.

10. A method for outputting audio data, the method comprising:
identifying audio data comprised of uncompressed audio data and compressed audio data to be output in response to a predetermined generated event;
playing back the uncompressed audio data and simultaneously decoding the compressed audio data; and
playing back the compressed audio data when the playback of the uncompressed audio data is completed.

11. The method as claimed in claim 10, wherein the compressed audio data corresponds to compressed data in a Moving Picture Experts Group-1 Audio Layer 3 (MP3) format, and the uncompressed audio data corresponds to uncompressed data in a Purse Code Modulation Wave (PCM Wave) format.

12. The method as claimed in claim 10, wherein the audio data comprises the uncompressed audio data prior to a playback start interval and comprises the compressed audio data after an end of the playback interval of the uncompressed audio data.
